(19) United States
(12) Patent Application Publication
(10) Pub. No.: US 2010/0103115 A1
(43) Pub. Date: Apr. 29, 2010

(54) DISPLAY ARRANGEMENT AND ELECTRONIC DEVICE

(75) Inventor: Richard HAINZL, SOLLENTUNA (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/257,835

(22) Filed: Oct. 24, 2008

(51) Int. Cl. G06F 3/041

(52) U.S. Cl. 345/173

(57) ABSTRACT

A display arrangement for portable electronic devices is disclosed. The arrangement comprises a display element comprising one or more layers arranged to provide electro-optical modulation of light or provision of patterned light for providing graphical content to a viewer, and a rigid protective layer; and a force sensitive layer arranged on, from a viewer, a distal side of the display element. An electronic apparatus comprising such an arrangement is also disclosed.

### TECHNICAL FIELD

The present invention relates to a display arrangement for electronic devices, and such an electronic device.

### BACKGROUND

Touch sensitive displays, popularly called touch screens, are widely used in user interfaces of electronic apparatuses. Traditionally, a transparent touch sensitive layer, e.g. working according to detection of resistive or capacitive changes as the layer is touched, is arranged on top of the display and the position being actuated by touch or tapping can be determined. The position can be determined by good accuracy, but the additional layer between the display and the user can be experienced as blurring the viewed image. Further, such a structure can be more sensitive to wear and damages. Touch sensitive displays which are more resistant to wear and damages may employ a strain gauge configuration where the screen is spring mounted on the four corners and strain gauges are used to determine deflection when the screen is touched. This makes mechanical mounting space consuming, and mostly too expensive for e.g. portable electronic devices or consumer products. Thus, there is a need for a structure of touch sensitive displays which overcomes or alleviates at least one or a few of the above demonstrated drawbacks.

### SUMMARY

The present invention is based on the understanding that

According to a first aspect, there is provided a display arrangement for electronic devices, comprising a display element comprising one or more layers arranged to provide electro-optical modulation of light or provision of patterned light for providing graphical content to a viewer, and a rigid protective layer; and a force sensitive layer arranged on, from a viewer, a distal side of the display element.

The rigid protective layer may be a glass layer or a layer of transparent and rigid polymer, such as polycarbonate or polymethyl methacrylate.

The force sensitive layer may be arranged only over a part of an area of the side of the display element.

The force sensitive layer may comprise at least one polyvinylidene fluoride film.

According to a second aspect, there is provided an electronic device comprising a display element comprising one or more layers arranged to provide electro-optical modulation of light or provision of patterned light for providing graphical content to a viewer, and a rigid protective layer; and a force sensitive layer arranged on, from a viewer, a distal side of the display element.

The rigid protective layer may be a glass layer.

The force sensitive layer may be arranged only over a part of an area of the side of the display element.

The force sensitive layer may comprise at least one polyvinylidene fluoride film.

The electronic device may be any of a mobile phone, a personal digital assistant, a digital camera, or a gaming console.

### BRIEF DESCRIPTION OF DRAWINGS

FIG. 1 schematically illustrates layer structure of a display element according to an embodiment of the invention.

FIG. 2 schematically illustrates layer structure of a display element according to an embodiment of the invention.

FIGS. 3a and 3b schematically illustrates an apparatus having a display arrangement according to an embodiment of the invention, where FIG. 3b is a section view along line A-A of FIG. 3a.

FIG. 4 schematically illustrates an alternative embodiment from a similar view as FIG. 3b.

FIGS. 5a and 5b illustrate a part of a display arrangement according to an embodiment of the invention, where FIG. 5b illustrates the display arrangement when a touch operation is present.

FIGS. 6 to 8 illustrate examples of apparatuses which can benefit of a display arrangement according to any of the embodiments demonstrated above, and examples of use.

FIGS. 9a and 9b illustrate a part of a display arrangement according to an embodiment of the invention, where FIG. 9b illustrates the display arrangement when a touch operation is present.

### DETAILED DESCRIPTION

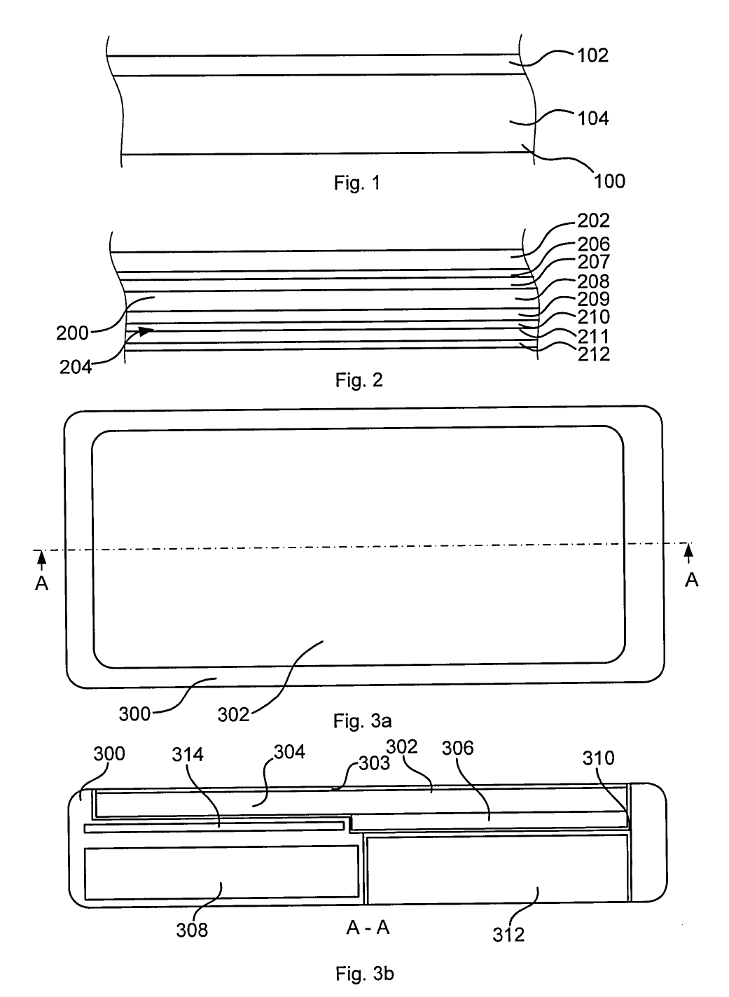

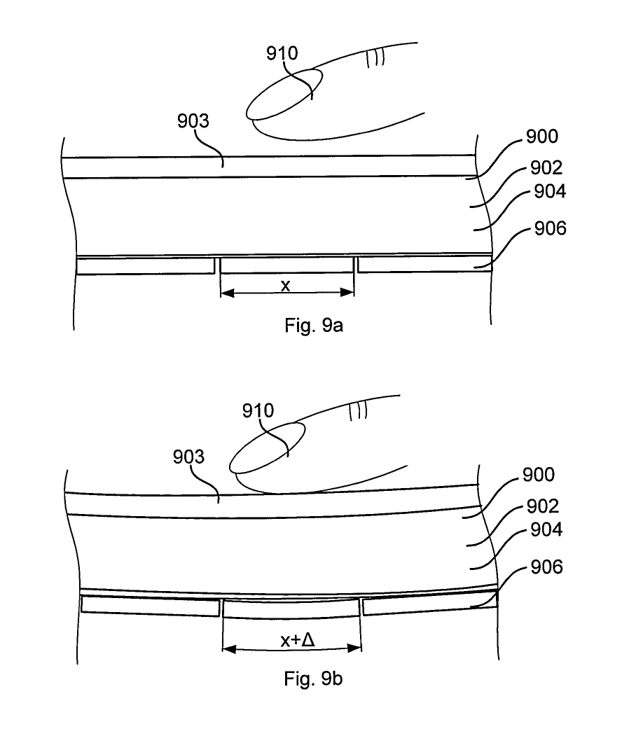

FIG. 1 schematically illustrates layer structure of a display element 100 according to an embodiment of the invention. The display element 100 comprises a rigid protective layer 102, which preferably is arranged at a side which in use is directed towards a viewer, and thus towards an outer surface of an apparatus in which the display element 100 is to be used, as will be further elucidated below. The rigid protective layer 102 will protect display layers 104 from being damaged during use. Especially, when the display element is tapped or pushed upon touch operation, the rigid protective layer 102 will protect the display layers 104 from breaking. The rigid protective layer 102, as well as the display layers, will upon application of a force allow small local deformation without breaking. This small local deformation will, as will be elucidated below with reference to FIGS. 5a and 5b, and FIGS. 9a and 9b, enable detection of the applied force, which detection will be detected on the “backside” of the display element, i.e. at the display layer side of the display element. Thereby, no touch sensors need to be applied “on top” of the display element, i.e. between the image generating layers and the viewer, which will facilitate maintaining good image quality. Often, applying touch sensitive layer on top of displays gives an experience of a blurry image. On the other hand, by applying touch sensor on the backside of the display element will only provide relatively low resolution of the touch input compared to when applying touch sensors on top. However, for many applications, e.g. virtual keys on the display, or selection of user interface items, the achieved resolution will be enough.

FIG. 2 schematically illustrates layer structure of a display element according to an embodiment of the invention. The display element 200 comprises a rigid protective layer 202, which preferably is arranged at a side which in use is directed towards a viewer, and thus towards an outer surface of an apparatus in which the display element 200 is to be used, as will be further elucidated below. The rigid protective layer 202 will protect display layers 204 from being damaged during use. The display layers 204 can comprise, in the case of a liquid crystal display, a polarizing layer 206, an electrode layer 207, a layer comprising crystal polymer 208, a further electrode layer 209, a further polarizing layer 210, a backlighting layer 211, which can be a light guide or a electroluminescent element, and a reflecting layer 212. Layers 206 to 212 are an example of layers that can be used for the electro-optical modulation of light for providing graphical content, and other configurations for providing electro-optical modulation of light for providing graphical content which are used in the art of display technology can be equally suitable. For provision of patterned light, a light emitting layer, e.g. an organic light emitting diode layer, can be provided as display layers 204. In this case, each picture element is provided by an addressable and illuminating part of the light emitting layer. This part can thus be controlled whether to provide light and preferably how much light that is to be provided. The principle of slight deformation upon application of a force without breaking the layers, as elucidated with reference to FIG. 1 above also applies here. This small local deformation will, as will be elucidated below with reference to FIGS. 5a and 5b, and FIGS. 9a and 9b, enable detection of the applied force, which detection will be detected on the “backside” of the display element, i.e. at the display layer side of the display element.

For the understanding of the function of the principle, the display element will be illustrated in its functional context before describing its function in detail. FIGS. 3a and 3b schematically illustrates an apparatus 300, where FIG. 3a is a front view of the apparatus 300. The apparatus 300 has a display arrangement 302 according to an embodiment of the invention. FIG. 3b is a section view along line A-A of FIG. 3a. Not to obscure the elements, FIG. 3b is made schematic and no crosshatchings are drawn. The display arrangement 302 comprises a rigid protective layer 303, which is arranged to form a part of the outer surface of the apparatus 300, and which is the display area which a user of the apparatus is experiencing, as illustrated in FIG. 3a. The protective layer 303 can be a glass layer, or a layer of transparent and rigid polymer, such as polycarbonate or polymethyl methacrylate. The display arrangement further comprises one or more display layers 304, as has been elucidated with reference to FIGS. 1 and 2. Attached to at least a part of the backside of the display arrangement 302, there is a force sensitive layer 306, e.g. made of polyvinylidene fluoride which has piezoelectric properties, from which deformation of any part can be converted into an electrical signal, e.g. by collecting signals from different parts of the force sensitive layer, or scanning a grid of electrodes applied to the force sensitive layer, such that the position where the force is applied can be derived by a processing means, preferably arranged in a circuitry part 308 of the apparatus 300. The force sensitive layer 306 preferably comprises one or more separate patches of such material where e.g. each patch is mapped to a recognisable position for detection.

The different elements of the apparatus 300 is supported and kept in place by a supporting structure 310. The apparatus can also comprise a battery 312 arranged to power supply the apparatus 300, and an antenna arrangement 314 arranged to receive and/or transmit data, e.g. for wireless communication, receiving broadcasted signals, or signals for determining position from a navigation satellite system. Further elements can be present, such as image acquiring means, wired interface, memory card interface, etc., depending on the type of apparatus. The circuitry part 308, which can be one or more elements although it here is depicted as a single element for the sake of easier understanding, can comprise processing means, memory circuits and/or devices, power circuitry, possible radio circuitry, interface circuitry, etc. which may be arranged on and interconnected by one or more printed circuit boards and their conductive traces, respectively.

The rigid protective layer 303, as well as the display layers 304, will upon application of a force allow small local deformation without breaking. This small local deformation will, as will be elucidated below with reference to FIGS. 5a and 5b, enable detection of the applied force, which detection will be detected by the force sensitive layer 306 on the backside of the display element 302. The force and deformation will propagate to the force sensitive layer 306, which will be squeezed between the display element 302 and the supporting structure 310 at a position corresponding to the part of the display element 302 where a user applies the force by touching or tapping the display surface, i.e. the rigid protective layer 303. Alternatively, the force sensitive layer is arranged to detect the deformation by being stretched together with the backside of the display element due to the curve implied by the deformation. This is particularly suitable for designs where a supporting structure 310 is not feasible or wanted for at least a part of the area to be detected. In the case of a polyvinylidene fluoride, this deformation will give rise to a piezoelectric effect, i.e. an electric charge, which can be collected by an electrode and be decoded by the processing means.

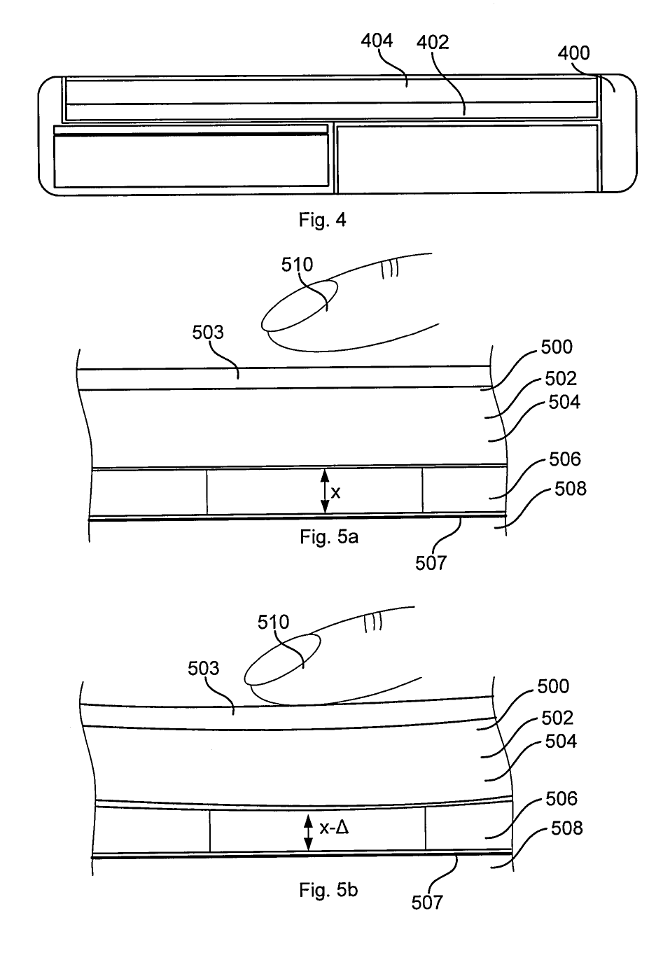

FIG. 4 schematically illustrates an alternative embodiment of an apparatus 400 from a similar view as FIG. 3b, where a sensor layer 402 covers the entire area of a display element 404. In other senses, the same features and options as those demonstrated with reference to FIG. 3b are applicable.

FIGS. 5a and 5b illustrate a part of a display arrangement 500 comprising a display element 502 according to any of the embodiments of display elements described above, comprising a rigid protective layer 503 and one or more display layers 504 and a force sensitive layer 506 arranged alongside the display element 502. A surface 507 of a supporting structure 508 is also illustrated.

In FIG. 5a, the display arrangement 500 is not yet touched or tapped by a user 510. In FIG. 5b, the user 510 applies a force on the rigid protective layer 503 by touching or tapping it, e.g. by a finger. The rigid protective layer 503, as well as the display layers 504, will upon application of the force allow small local deformation without breaking.

In FIG. 5b, the illustration of the deformation is for providing understanding of the principle and may be exaggerated for illustrative purposes. This small local deformation will, by deformation Δ of the force sensitive layer 506 at a position corresponding to the position where the user 510 touches or taps the display element 502, enable detection of the applied force and the position, which detection can be provided as an electrical signal to be decoded by a processing means. The force sensitive layer 506 can comprise pads of polyvinylidene fluoride film, or other force sensitive elements. These can be arranged at spots to be defined positions to be detected.

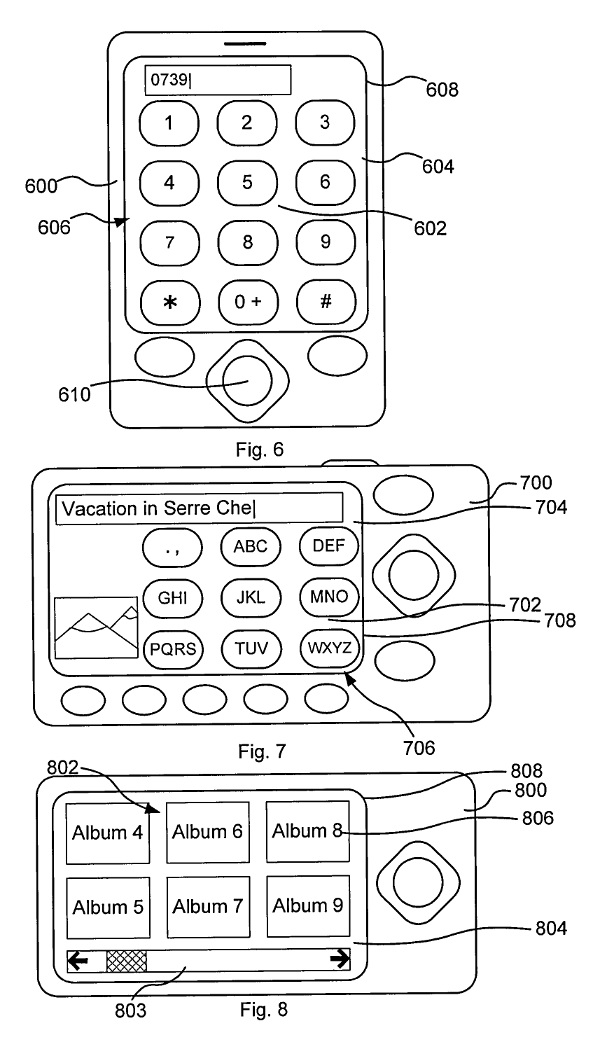

FIGS. 6 to 8 illustrate examples of apparatuses which can benefit of a display arrangement according to any of the embodiments demonstrated above, and examples of use.

FIG. 6 illustrates an example apparatus 600, here a telephone, where upon need to dial a telephone number, an image of a keypad 602 is displayed on the screen 604 and the user can dial the telephone number by tapping the displayed keys 606 and the display arrangement 608, which is of the type elucidated above, will be able to detect the tapped positions with accuracy enough to enable the dialing. The apparatus can also have other input means, e.g. a navigation input means 610. This is an example of an application where demand on resolution of the detected position is moderate, and for which this is an efficient solution. In the illustration, it can be seen that a part of the display is used for the input, and another part is used for presenting the dialed digits.

FIG. 7 illustrates an example apparatus 700, here a digital camera, where upon wish to input meta data, such as text, to a captured picture, an image of a keypad 702 is displayed on the screen 704 and the user can input the text by tapping the displayed keys 706 and the display arrangement 708, which is of the type elucidated above, will be able to detect the tapped positions with accuracy enough to enable the input.

FIG. 8 illustrates an example apparatus 800, here a media player, where upon browsing among stored media content, an image of items 802 associated with available content, optionally scrollable by tapping or sliding scrollbar 803 as illustrated, is displayed on the screen 804 and the user can select content to be rendered by tapping a displayed item 806 associated with the media content. The display arrangement 808, which is of the type elucidated above, will be able to detect the tapped positions with accuracy enough to enable the selection.

FIGS. 9a and 9b illustrate a part of a display arrangement 900 comprising a display element 902 according to any of the embodiments of display elements described above, comprising a rigid protective layer 903 and one or more display layers 904 and a force sensitive layer 906 arranged alongside the display element 902.

In FIG. 9a, the display arrangement 900 is not yet touched or tapped by a user 910. In FIG. 9b, the user 910 applies a force on the rigid protective layer 903 by touching or tapping it, e.g. by a finger. The rigid protective layer 903, as well as the display layers 904, will upon application of the force allow small local deformation without breaking.

In FIG. 9b, the illustration of the deformation is for providing understanding of the principle and may be exaggerated for illustrative purposes. This small local deformation will, by deformation Δ of the force sensitive layer 906 which stretches at a position corresponding to the position where the user 910 touches or taps the display element 902, enable detection of the applied force and the position, which detection can be provided as an electrical signal to be decoded by a processing means. The force sensitive layer 906 can comprise pads of polyvinylidene fluoride film, or other force sensitive elements. These can be arranged at spots to be defined positions to be detected.

According to an embodiment, the touch sensitive layer only cover the part of the display that need to be used for input. This can save costs and/or space.

The above given examples can of course be combined in a multitude of ways, e.g. text input in a media player for searching for a content, item selection in a telephone or camera for enabling a menu system, input to a game console for controlling the game, input and menu selection in a personal digital assistant, etc.

1. A display arrangement for portable electronic devices, comprising
a display element comprising one or more layers arranged to provide electro-optical modulation of light or provision of patterned light for providing graphical content to a viewer, and a rigid protective layer; and
a force sensitive layer arranged on, from a viewer, a distal side of the display element.

2. The display arrangement according to claim 1, wherein the rigid protective layer is a glass layer, or a layer of transparent and rigid polymer, preferably polycarbonate or polymethyl methacrylate.

3. The display arrangement according to claim 1, wherein the force sensitive layer is arranged only over a part of an area of the distal side of the display element.

4. The display arrangement according to claim 1, wherein the force sensitive layer comprises at least one polyvinylidene fluoride film.

5. A portable electronic device comprising
a display element comprising one or more layers arranged to provide electro-optical modulation of light or provision of patterned light for providing graphical content to a viewer, and a rigid protective layer; and a force sensitive layer arranged on, from a viewer, a distal side of the display element.

6. The portable electronic device according to claim 5, wherein the rigid protective layer is a glass layer.

7. The portable electronic device according to claim 5, wherein the force sensitive layer is arranged only over a part of an area of the side of the display element.

8. The portable electronic device according to claim 5, wherein the force sensitive layer comprises at least one polyvinylidene fluoride film.

9. The portable electronic device according to claim 5, being any of a mobile phone, a personal digital assistant, a digital camera, or a gaming console.
